(19) United States
(12) Patent Application Publication
(10) Pub. No.: US 2009/0100326 A1
(43) Pub. Date: Apr. 16, 2009

(54) SYSTEM AND METHOD FOR AUTOMATED FORM COMPLETION

(76) Inventor: Thomas McCormick, Warwick, RI (US)

Correspondence Address: BURNS & LEVINSON, LLP, 125 SUMMER STREET, BOSTON, MA, 02110, US

(21) Appl. No.: 12/248,489

(22) Filed: Oct. 9, 2008

Related U.S. Application Data
(60) Provisional application No. 60/978,822, filed on Oct. 10, 2007.

(51) Int. Cl. G06F 17/00

(52) U.S. Cl. 715/226

(57) ABSTRACT

The invention enables automated form completion and comprises a combination of a graphical user interface, a database, one or more forms, a logic engine, and operational protocol. After a user's information is collected, the logic engine automatically creates an FDF file of the completed form, which may be sent electronically to predetermined recipients.

This application claims the priority date of Provisional Application Ser. No. 60/978,822, entitled SYSTEM AND METHOD FOR AUTOMATING DATA MANAGEMENT, filed on Oct. 10, 2007, which this application incorporates by reference in its entirety.

### BACKGROUND

The present teachings relate generally to form completion. What is needed are a system and method for automating form completion.

### SUMMARY

The needs set forth herein as well as further and other needs and advantages are addresses by the present embodiments, which illustrate solutions and advantages described below.

The method of the present embodiment automates form completion, comprising steps of enabling selection of one or more forms for completion, collecting user data required to complete the selected form(s), and creating electronic file(s) of the completed form(s), although not limited to this embodiment. The system of the present embodiment includes, but is not limited to, components for carrying out the method of the present embodiment.

Other embodiments of the system and method are described in detail below and are also part of the present invention.

### BRIEF DESCRIPTION OF THE DRAWINGS

For a better understanding of the invention, together with other and further aspects thereof, reference is made to the accompanying drawings and detailed description, wherein:

FIGS. 1, 1A and 2 are flowcharts of methods of one embodiment;

FIGS. 3-5 are examples of graphical user interface;

FIGS. 6 and 6A are flowcharts of an alternate embodiment;

FIGS. 7-10 are more examples of graphical user interface;

FIG. 11 is a schematic block diagram of one embodiment of the system;

FIG. 12 is a schematic block diagram of one embodiment of a computer and program server; and

FIGS. 13 and 13A are more examples of graphical user interface.

### DETAILED DESCRIPTION

The present embodiment is described more fully hereinafter with reference to the accompanying drawings, in which the present embodiments are shown. The following description is presented for illustrative purposes only and the invention should not be limited to these embodiments. Any computer configuration and architecture satisfying the speed and interface requirements herein described may be suitable for implementing the system and method of the present embodiment.

The invention relates generally to the field of form completion. In many instances people are required to complete complicated forms. Often multiple forms are used by a bureaucracy to collect information. As an example, although not limited thereto, a single visit to a health care provider may require a patient to complete multiple forms that collect redundant information. These forms are not only complicated, but because they are often completed on paper, they cannot be electronically transmitted immediately and may present problems with security and poor penmanship.

The housing industry similarly requires the completion of many forms by housing applicants. Each housing office may have particular needs and forms for data collection. Housing offices may include any entity that rents, sells, manages, or advertises housing, although not limited to these. Housing offices may include universities, military branches, apartment complexes, real estate owners and managers, multi-dwelling units, office buildings, construction firms or non-profit organizations, although not limited to these.

For example, the United States Armed Services have uniformed and non-military personnel (civilians) and their families moving to U.S. and foreign military installations to reside for variable durations. Other organizations have similar incidents of relocation. Each move involves filing considerable paperwork with the relevant housing office to apply for and secure residential housing. These forms are complicated and difficult to complete and differ at each military post. The system takes into account each housing office's particular form requirements and provides selection of the those particular forms to a user.

Forms associated with housing may include Incoming forms (e.g., Housing Application, etc.), On-post forms (e.g., Pet Addendum, Change in the Number of Occupants, Permission To Enter, Key Release, Real Estate Lease, Satellite Addendum, Fence Request, Power of Attorney, etc.), and Vacating forms (e.g., Notice To Vacate, etc.). It is to be appreciated that these are examples of some of the forms associated with managing housing and the invention should not be limited to these particular forms, nor to housing forms in general.

What is needed are a system and method for automating the process of form completion. The present teachings may eliminate the complication and duplicative effort associated with completing forms by simplifying the user's data entry, information storage, and automating the process of form completion and distribution. The user of the system of the invention supplies information, which may be stored in a database and used to automatically complete various forms simultaneously. The user's information can also be retrieved for later use on subsequent forms, although not limited to this embodiment. Completed forms may be stored and made available for viewing, printing, and other tasks including, but not limited to, program integration. The completed forms may also be automatically sent to predetermined recipients in whole or by reference, although not limited to this embodiment.

The present embodiment comprises a combination of a graphical user interface, a database, one or more forms, a logic engine, and operational protocol, although not limited to this embodiment. After a user's information is collected, preferably through a simple graphical user interface, the logic engine creates a forms data format (“FDF”) file that, when accessed, will open in a portable document format (“PDF”) document, the form having been completed with the user's information, although not limited to this embodiment.

The system administrator may have one or more forms in electronic format to be completed by the system user. The system administrator may assign form fields to each element of an electronic form that requires user information. This may be accomplished with an application such as Adobe Acrobat, although not limited to this application. Each field on the form may be given a field name, field size, and association to a database field of user information. The form field may provide space on the electronic form for the electronic placement of user information.

A user of the system may log into the system and select from multiple form(s) to be completed. A simple graphical user interface may show input fields for each piece of information needed to complete the selected form(s). If the user supplied his or her information to the system in the past, he or she may log into an account on the system using a username and password previously created and the stored information may be pre-filled in the input fields.

When all of the required information has been acquired by the system, the user may submit the information and FDF files may be automatically created at once. Since the system administrator has associated each form field with user information stored in the database, the system may loop through the form fields on each selected form and fill in the appropriate user information electronically. Once this is done, each completed form will have user information printed electronically in each form field. The system may then save the completed form electronically to computer-readable media. When a user tries to open the electronic file, it may open as a PDF document.

After the forms are completed and the electronic files stored on a server, an e-mail containing a link to the FDF file may be sent electronically to the relevant housing office, although not limited to this embodiment. This automation may save both time and administrative expense, simplifying work for the housing office. A confirmation e-mail and copies of the completed forms may also be sent to predetermined recipients (e.g., the user, etc.) to provide a record of delivery.

Once a user has set up an account on the system and supplied his or her information, subsequent forms may be completed quicker and more efficiently. The next time a user needs to complete a form, he or she may simply return to the system and log in using his or her username and password. The system may show the user's previously entered information in corresponding input fields and save any updated information. If a user has forgotten his or her username or password, the system can email them to the user.

The system may provide additional levels of security to assure that a user's information is kept safe and secure. For example, although not limited thereto, 128-bit Secure Sockets Layer encryption may be used to protect any data transmissions occurring over the Internet.

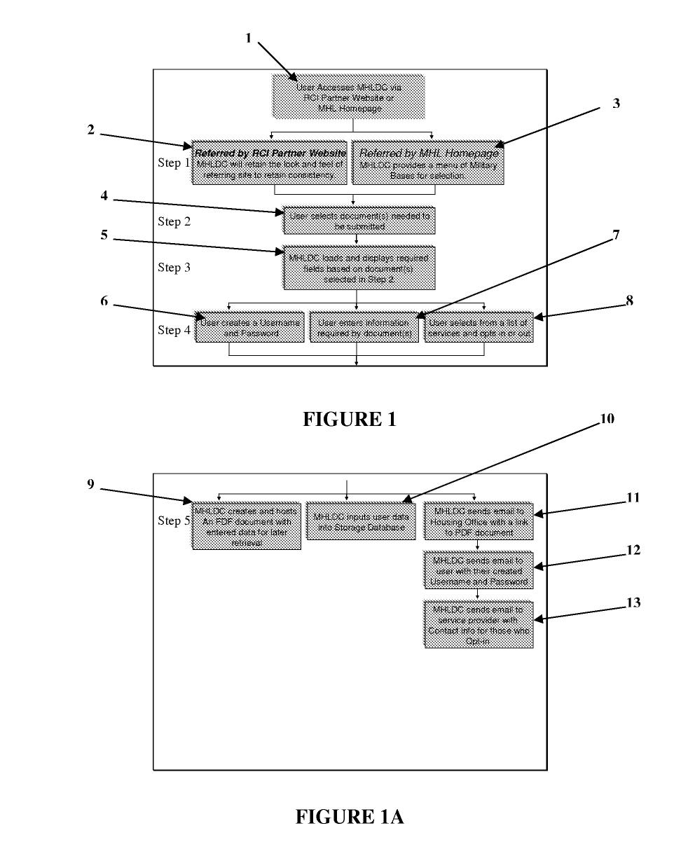

Referring now to FIG. 1, shown is a flowchart of one embodiment of the method of the invention used for military base housing, although not limited to this embodiment. A user such as a soldier to be transferred, although not limited thereto, may first access a website having the graphical user interface of the invention 1. Use of a website to host the system is but one example of the many technologies that may be used and the invention should not be interpreted as being limited to this embodiment. For example, although not limited thereto, a client-based application may be used. In step 1, if the user was referred to the system (“Military Home Link Document Center” a/k/a “MHLDC”) by a partner website (“Residential Communities Initiative partner” a/k/a “RCI partner”), the referring website's look and feel can be retained for a consistent web experience 2. In this way it can appear to the user that they never left the referring website. This may be accomplished by using the referring website's own header, footer, and style sheet, although not limited to this embodiment. The header and footer may be copied from the referring site and incorporated into the system's graphical user interface. The system may reference the referring site's style sheet over the Internet.

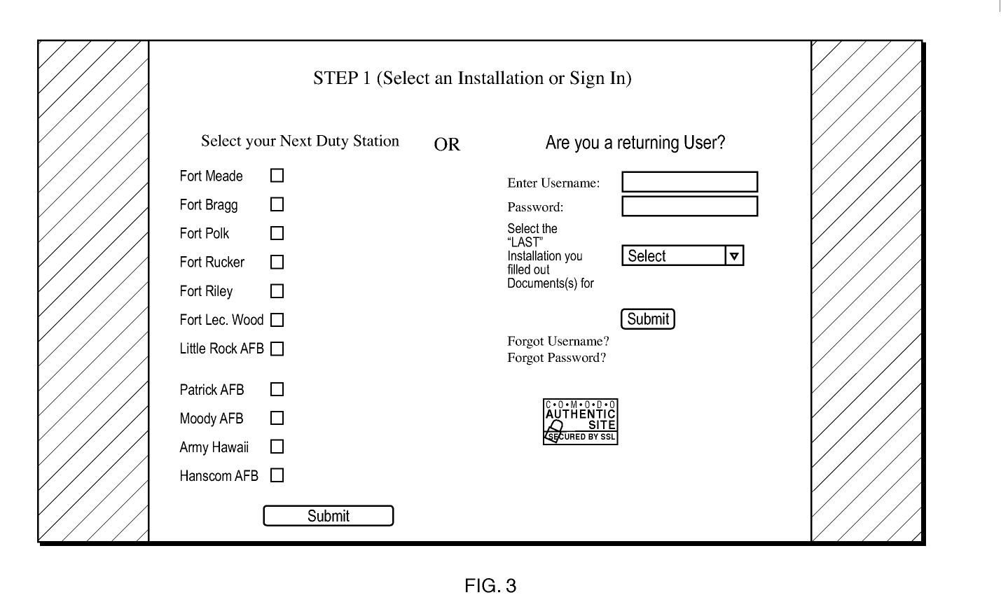

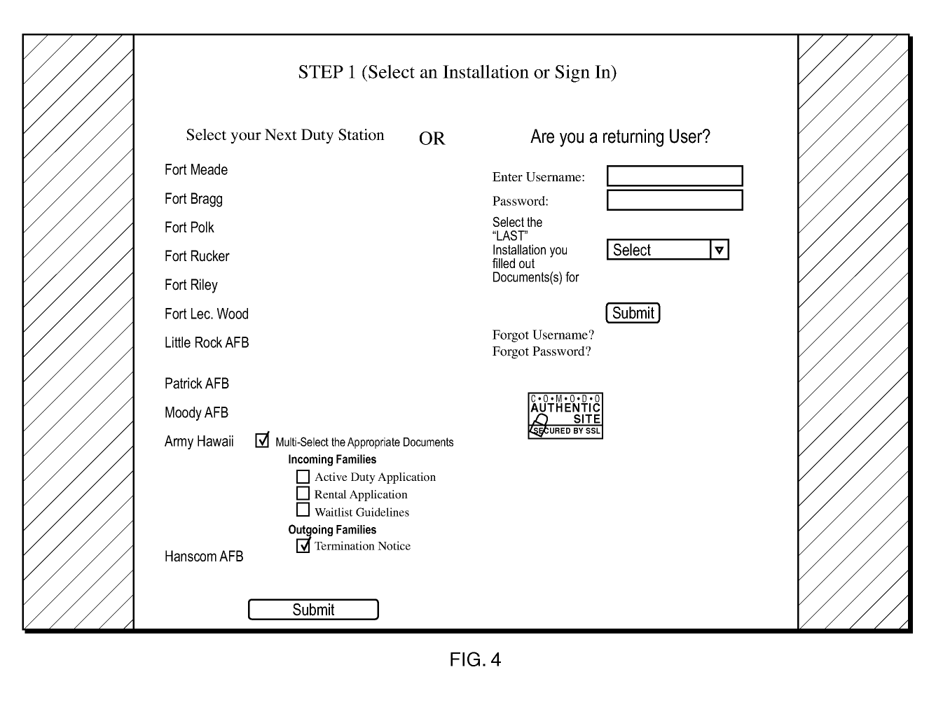

If the user was referred by the system home page (“MilitaryHomeLink.com” a/k/a “MHL”) or any other outside source, the user may be given a list of available military bases for selection 3 (Shown in FIG. 3). This step may be skipped if the user was referred by a particular military base website.

In step 2, based upon the military base selected in step 1 or the referring military base partner website, the graphical user interface may then allow the user to select from a variety of forms available to be completed for that particular military base 4 (Shown in FIG. 4). In this example, the system is used to help a user complete military housing forms, but the invention should not be interpreted to be limited to this particular use. In fact, any time a user needs to complete forms is a potential use for this invention, whether related to housing, the military, or otherwise.

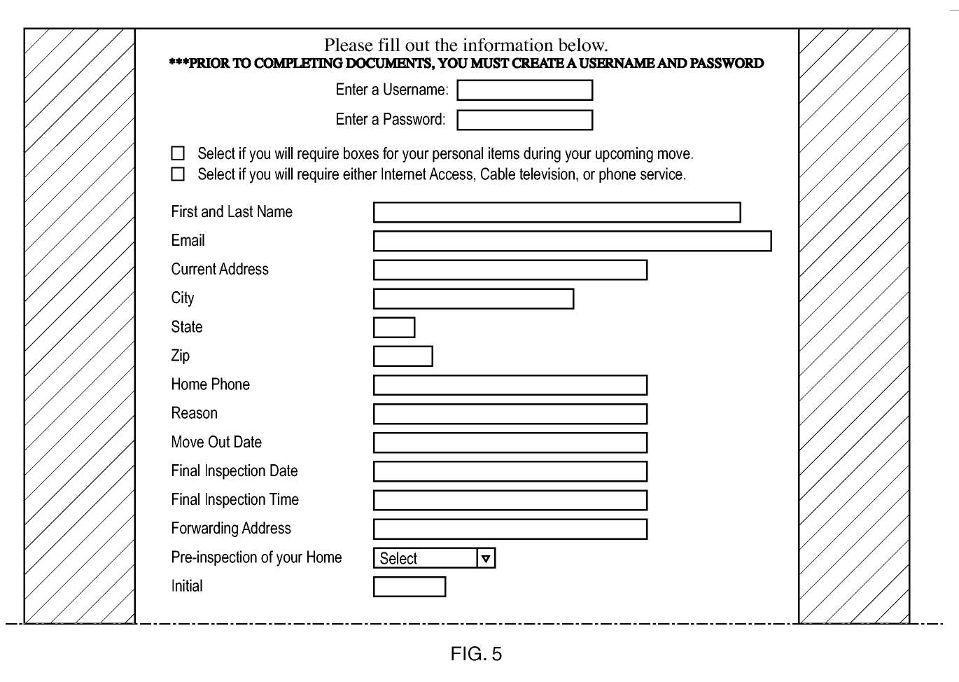

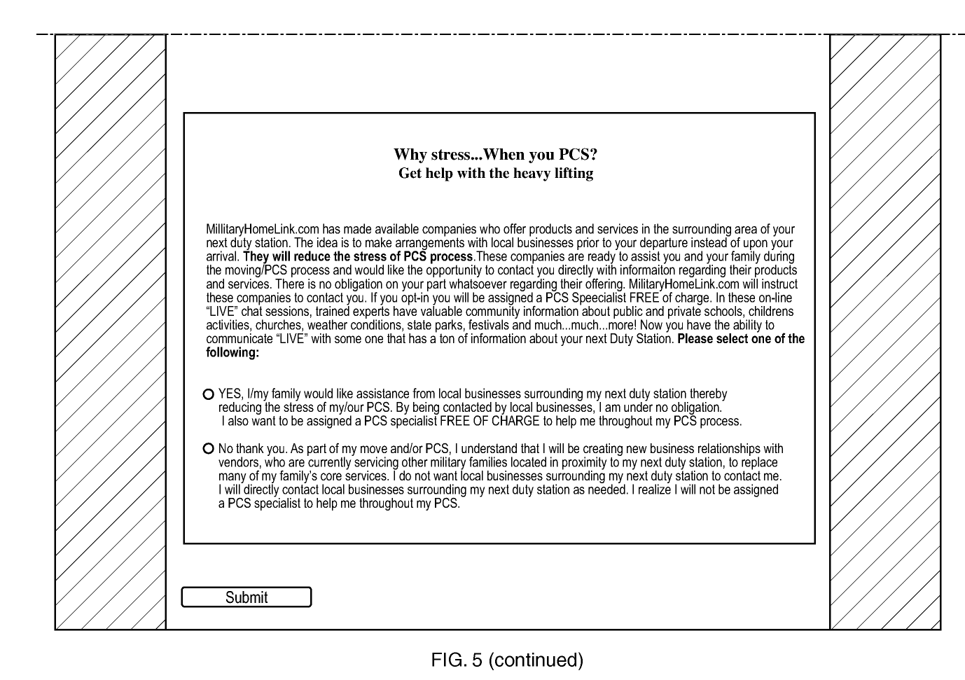

In step 3, based upon the form(s) the user selected in step 2 4, the graphical user interface may provide input fields for every piece of information needed to complete the selected form(s) 5 (Shown in FIG. 5). A user may choose to fill out several forms simultaneously. Since many forms require the same information, that information only needs to be collected once, simplifying data entry for the user. This information may be used to simultaneously populate each of the selected form(s).

In step 4, the user may enter any information needed to complete the selected form(s) 7, along with a username and password 6 (Shown in FIG. 5). If the user does not already have an account on the system, a new account may be created. With an account on the system, the user's information may be stored in a database for later use on subsequent forms, although not limited to this embodiment.

The user may also choose to opt-in or opt-out from a list of predetermined services relevant to the forms completed 8. For example, if the user is completing forms for moving to a new residence, he or she may opt to receive marketing information from local utility companies or other goods/services providers.

Referring now to FIG. 1A, shown is a flowchart continuing from FIG. 1. In step 5, after the user submits his or her information to the system through the graphical user interface, the information may be saved to a database 10. A logic engine may create FDF file(s) of the completed form(s) with user information 9. The FDF file(s) may be kept for long-term storage and sent to selected recipients such as the housing office, either encrypted or unencrypted. In the alternative, the completed form(s) may be made publicly accessible and a hyperlink may be sent to the predetermined recipients 11, either encrypted or unencrypted.

If the user created a new system account, his or her new username and password may be sent electronically to the user for his or her record 12. If the user chose to receive any services, those service providers may also be notified 13.

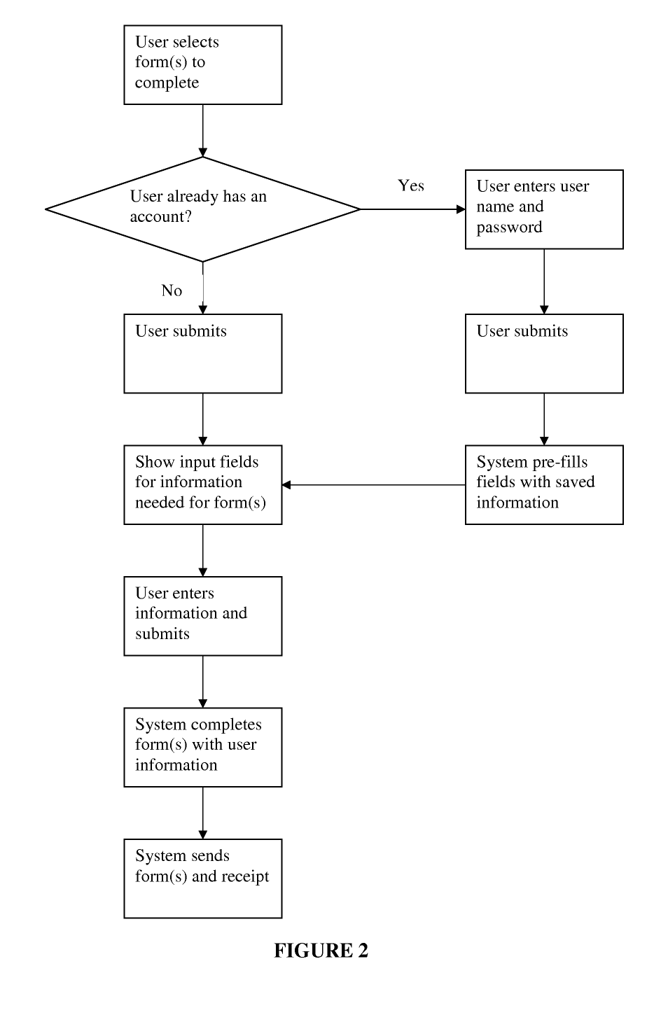

Referring now to FIG. 2, shown is another flow chart of one embodiment of the method of the invention. The user may first select which form(s) to complete. If the user already has an account on the system, he or she may log in (Shown in FIG. 4) prior to selecting form(s) to complete. The system next may display the relevant input fields needed to complete the selected form(s). If the user entered a valid username and password, any information saved in the database for that account may be pre-filled into the appropriate input fields. The user may fill out any remaining input fields, update any old information, and enter a username and password if he or she doesn't already have an account on the system. After the user submits the information, the system may create corresponding FDF files of the selected form(s) with the user's information. Links to the FDF files may then sent to predetermined recipients with a receipt to the user. A receipt may include links to any FDF files or a delivery notification. If the user created a new account using a new username and password, those may be electronically sent to the user.

Referring now to FIG. 3, shown is an example of graphical user interface. It is to be appreciated that this example of a graphical user interface, along with all other examples found herein, is offered to help explain the system and it should not be limited to this particular graphical user interface. It is appreciated that many other technologies, configurations, and modifications could be used. In a typical military housing scenario a housing applicant would select his or her next duty station. The graphical user interface may provide a list of available military bases on the left of the screen. On the right of the screen, the user may enter a username and password so that any information stored in the database may be recalled for use in subsequent steps.

Referring now to FIG. 4, shown is an example of a graphical user interface which may be used to select any forms the user wishes to complete. The forms available for completion may be based on the user's needs. For example, although not limited thereto, in the military housing scenario the forms may be based upon the military base selected in FIG. 3 so that only forms specific to that military base are shown to the user. In this example, “Army Hawaii” has been selected and the available forms for that housing office have been dynamically displayed on the same web page. As the user scrolls over the available forms, a pop-up box may appear containing a description of the form's intended purpose, although not limited to this embodiment.

Each housing office may set up specific forms in the system it requires users to complete. Each housing office may supply those forms to a system administrator who reviews the forms to determine what user data needs to be collected and formats the forms electronically so that user data may be populated into each field. In this way, each housing office's specific requirements may be satisfied by the system's automated data collection, form completion, and form submission.

Referring now to FIG. 5, shown is an example of graphical user interface which may be used to collect the information required to complete the form(s) selected in FIG. 4. Any number of fields may be shown to acquire the necessary information. Since many forms require the same information, for example, name and address, if a user selected multiple forms for completion then the name and address will only need to be captured once. The form fields on multiple forms for “name” may be associated with the same database field of user information, although not limited to this embodiment. Therefore, the “name” input fields would only need to be displayed once to the user. In addition, only the information relevant to the selected form(s) needs to be collected and those fields shown to the user, limited to only the information needed to complete the selected form(s). This makes the completion of any number of forms quick and easy for the user. And with an intuitive graphical user interface there is much less cause for confusion. If the user entered a valid username and password in a previous step, any information for that user stored in the system may be pre-filled in the input fields. The user may then have the chance to edit any of the information pre-filled into the input fields.

When a user moves to another housing installation, he or she can simply log into the system and use his or her information stored in the database to auto-populate any selected form(s) for that housing office. If the system is web-based, this information may be accessible from any computer on the Internet. In this way, the system may allow military soldiers to apply for housing in advance such as, for example, prior to their return to the United States from abroad. This may be helpful for anyone that moves frequently. Examples are college students and college housing offices, non-profits, government agencies, and large apartment complexes, although not limited to these embodiments. The system not only makes completing forms much easier for the user, but improves the quality and consistency of the data that each housing office receives.

Still referring to FIG. 5, if the user does not have an account on the system, the user may enter a new username and password to create an account before continuing. In this way, all of the most recent user information may be stored in the system for later use, obviating the need for future data re-entry.

Opt-in/opt-out selections may also be included at this stage, although not limited to this embodiment. The available goods and services may be customized for the particular user, geographical region, or form selection, although not limited to this embodiment. For example, although not limited thereto, is a user has selected forms indicating he or she is moving out of an accommodation, services may include moving companies. In the same way, if the user has selected forms indicating he or she is moving into an accommodation, services may include local newspaper delivery, cable companies, or other utilities. The service/goods provider(s) may then be directly contacted by the system with the relevant user information. Relevant user information may include the user's name, contact information, and housing status, although not limited to this embodiment. The service/goods provider may then contact the user to offer the relevant services or goods, although there may be no obligation for the user to purchase any of them.

Once all of the information required to complete the selected form(s) is collected, the system may automatically create electronic FDF file(s) of the form(s) filled out with the user information. The created file(s) may be sent electronically to the relevant housing office or other recipient for action, or may be printed out and sent manually. In addition, a link to the created file(s) may be mailed electronically to the recipient, who may then retrieve the file(s) from the system. It is appreciated that any number of notifications may be used to alert a predetermined list of recipients of the user's action, and the invention is not limited to these particular embodiments.

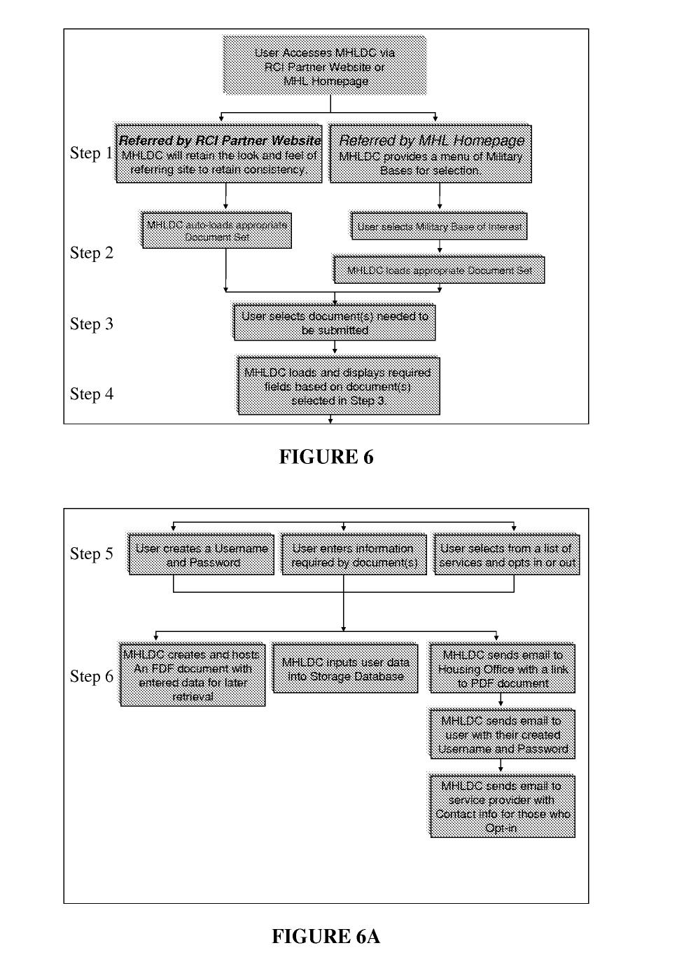

Referring now to FIGS. 6 and 6A, shown are flow charts depicting an alternative embodiment of the method of the invention. These flow charts are substantially similar to those depicted in FIGS. 1 and 1A, with the exception of additional actions at step 2. As shown in step 2, a user first selects a housing office and submits that choice to get to the next step showing available forms. Since there may be any number of housing offices in any number of different industries, the system may have any number of steps to narrow down the list of forms for selection when a user enters from a more general portal. In the military housing context, only forms appropriate to a particular based are shown. In the alternative, although not limited thereto, if the user enters the system from a more general portal, he or she may be asked to first choose a region, military branch, or military base of interest. Once narrowed down, all relevant forms may be shown and the user may select any he or she wishes to complete.

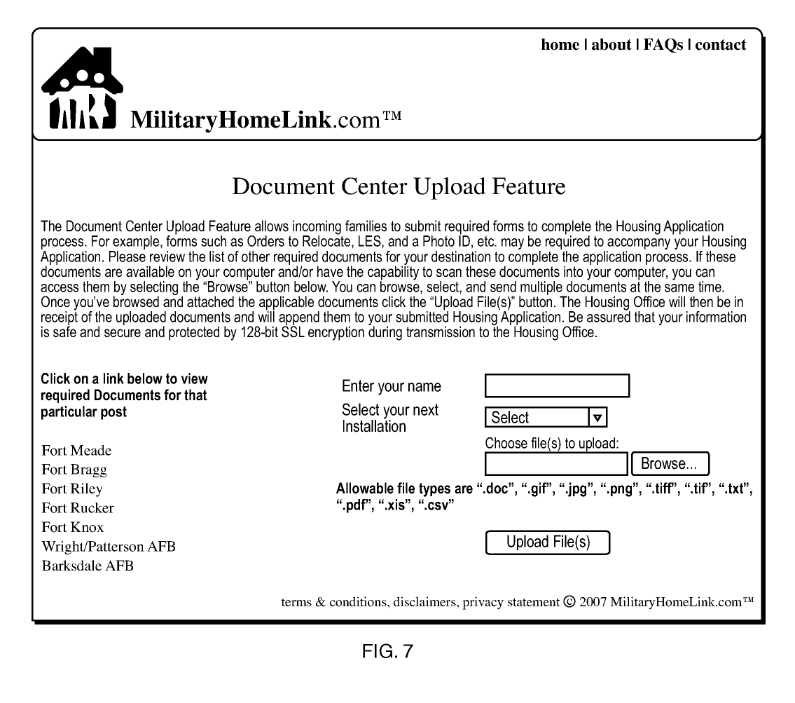

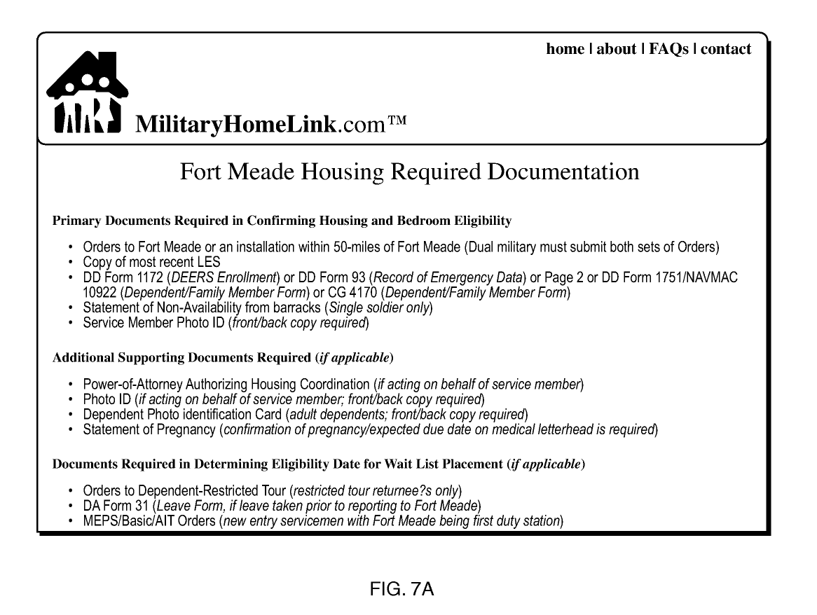

Referring now to FIGS. 7 and 7A, shown are more examples of graphical user interface. The invention may have a document upload feature, although not limited to this embodiment. The document upload feature may allow users to submit additional required documents. For example, although not limited thereto, forms such as photo identification, military orders, marriage certificates, or birth certificates may be required in some instances to accompany a housing application. Submitting these in this way simplifies and speeds the process of securing housing because the application is accompanied by all of the required ancillary documentation. Each housing office may have different requirements for additional documentation (Shown in FIG. 7A).

A user may browse, select, and send multiple documents to the system, thereby providing the housing office with the additional documentation at the time the completed housing forms are submitted. The upload feature may be made available after the user has selected which forms to complete, although not limited to this embodiment. At this point, the system may know which additional documents, if any, are required by the housing office. The additional documents may be stored on the system and forwarded automatically to predetermined recipient(s). This feature may be helpful in cases such as, for example, although not limited thereto, when a housing officer wishes to place a user on a housing waitlist, which may require additional documentation.

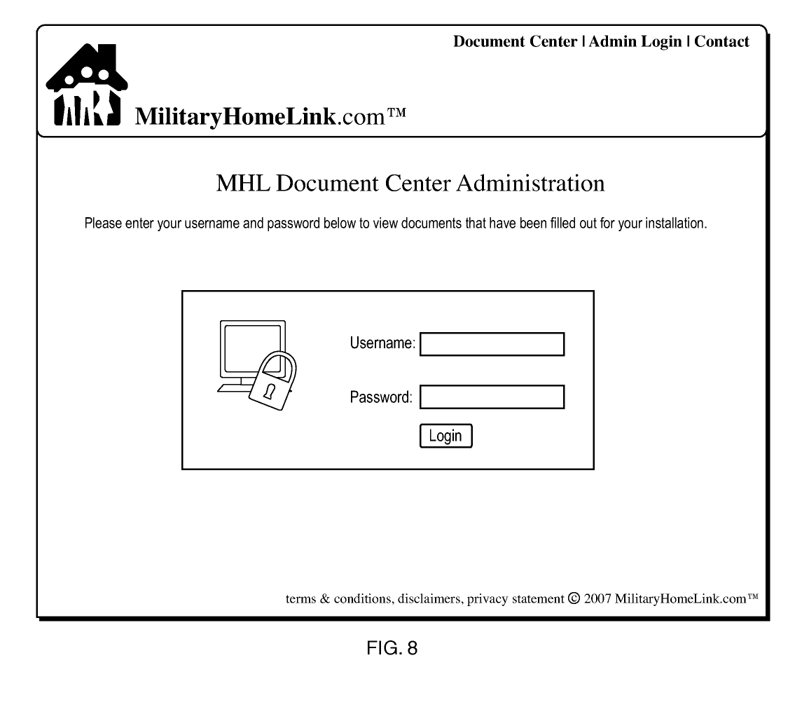

Referring now to FIGS. 8-10, shown are examples of graphical user interface for system management. Shown in FIG. 8, the management system may be a password protected area that displays dates, times, user names, and links to every document submitted to a particular housing office. Only pre-authorized housing personnel may have access to this area. Instead of sifting through correspondence, a housing office could log in to the management system to view documents in a central location.

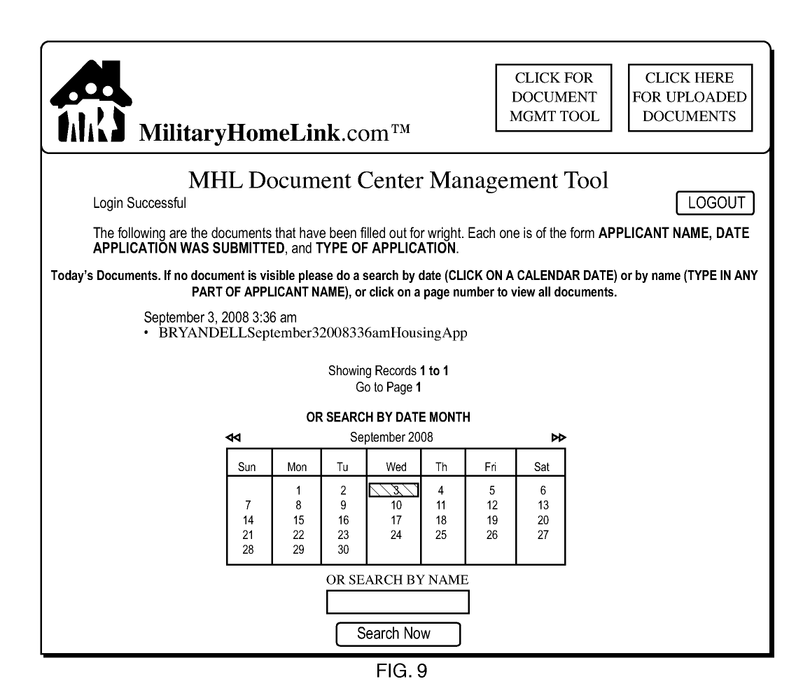

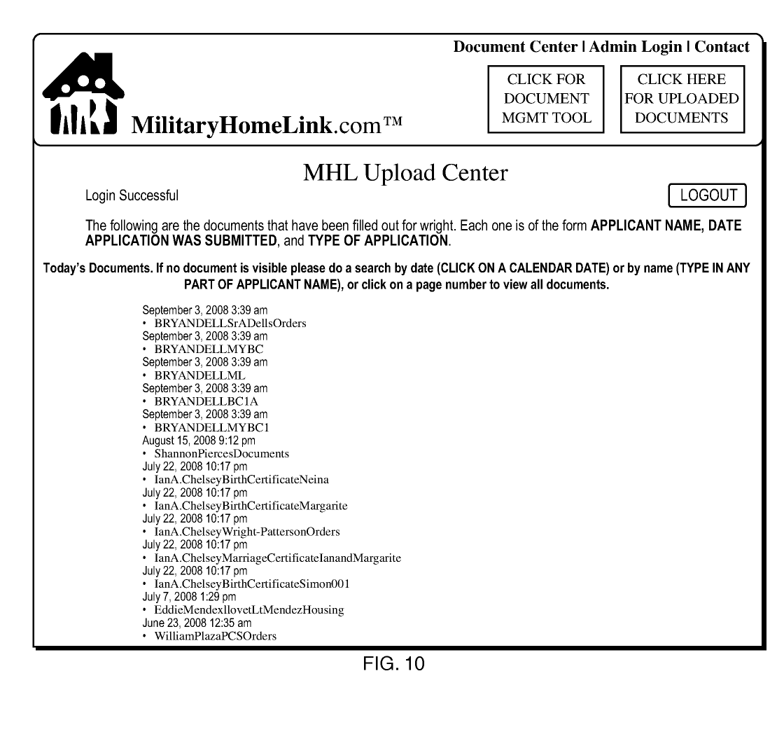

Shown in FIG. 9, the management system may have a search feature so that the housing officer may enter all or part of a user's name to find documents submitted by that user. There may also be a calendar so that the housing officer can search all documents submitted on a particular day, week, or month. Shown in FIG. 10, the management system may also provide a list of all completed forms and uploaded documents sorted in order by, for example, submission date, although not limited to this embodiment.

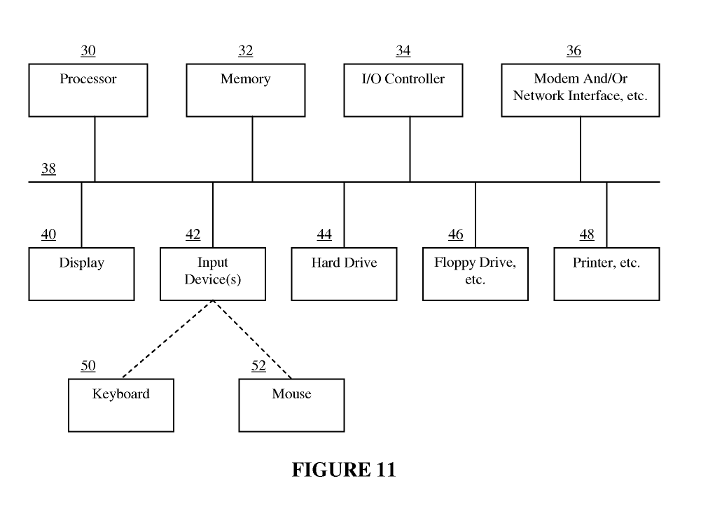

Referring now to FIG. 11, shown is a schematic block diagram of one embodiment of the system of the invention. The methods of the disclosed embodiments may be accomplished by one or more persons operating a computer system programmed to assist in the execution of the method. The system may include components such as, although not limited thereto, a central processor 30, a main memory unit 32 for storing programs and/or data, an input/output (I/O) controller 34, a display device 40, and a data bus 38 coupling these components to allow communication there between. The memory 32 may include random access memory (RAM) and read only memory (ROM) chips, although not limited to this embodiment. The system may also have one or more input devices 42 such as a keyboard 50 and a mouse 52. The system also may have a hard drive 44 with hard disks therein and a floppy drive 46 or similar device for loading portable memory. The system may also have a data communications interface 36 to allow communication with other computers on an intranet or internet, such as a modem, an Ethernet card, or other network interface. Other devices also may also be part of the system, including output devices 48 (e.g., printer or plotter) and/or optical disk drives for receiving and reading digital data on a CD-ROM.

One or more computer programs may define the operational capabilities of a computer to assist in execution of the methods of the invention. These software programs may be loaded onto the hard drive 44 and/or into the memory 32 of the computer via the floppy drive 46 or the data communications interface 36, although not limited to this embodiment.

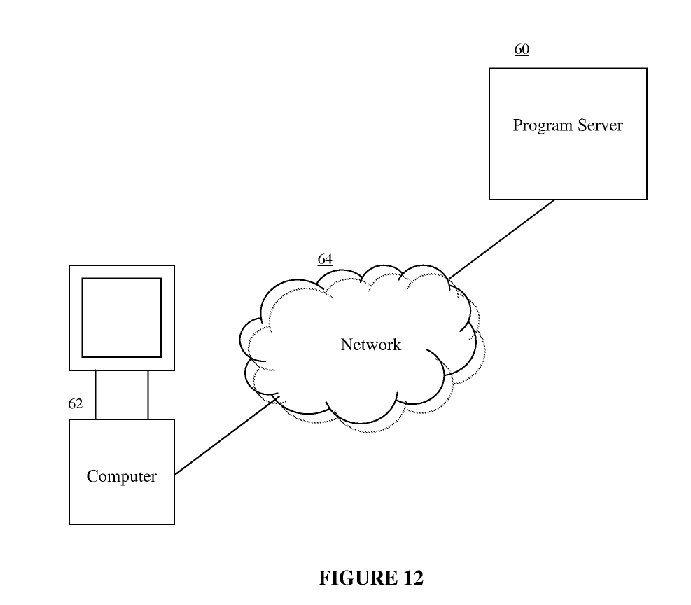

Referring to FIG. 12, shown is a schematic block diagram of one embodiment of a computer and program server. A computer 62 may be connected to a network 64 via a data communications interface 36 (Shown in FIG. 11). Computer programs that implement an embodiment of the invention may be stored on a program server 60, which is another computer that can be implemented as the type disclosed in FIG. 11. A server may have high performance components such as those shown in FIG. 11. The programs may be stored on the server 60 in any number of programming languages. The computer 62 may run commercially available world wide web browser software such as, although not limited thereto, Netscape Navigator or Microsoft Explorer. The browser software may download program content from the program server 60 and communicate with the program server 60 to execute the programs. The use of a network 64 and browser software makes the programs available simultaneously to large number of computers on the network.

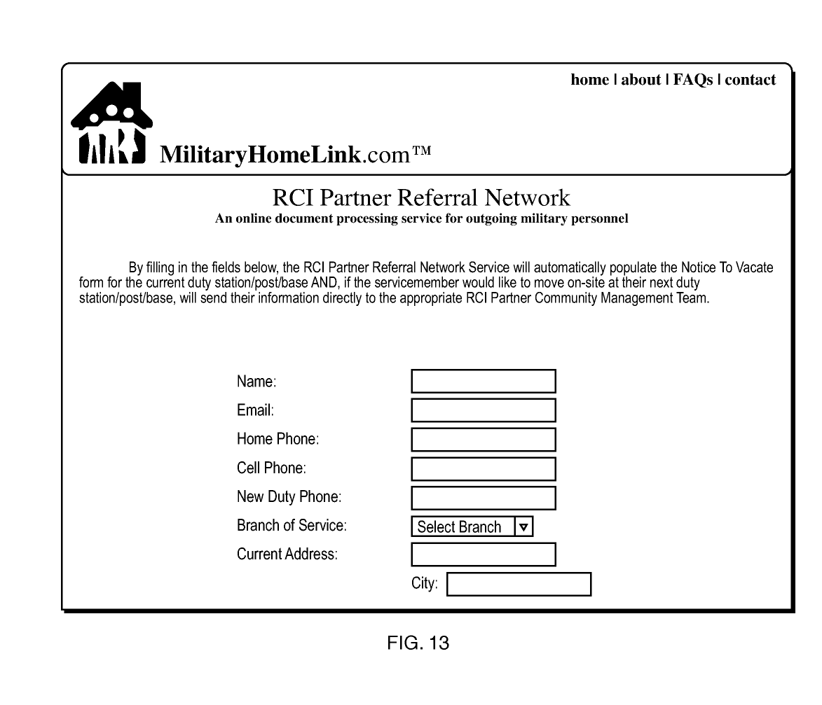

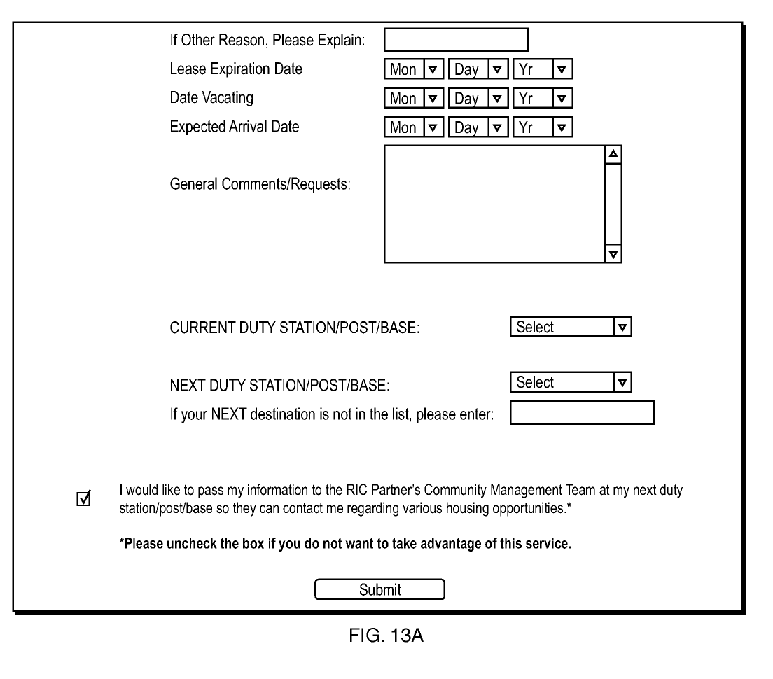

Referring to FIGS. 13 and 13A, shown are more examples of graphical user interface. In the military housing context, although not limited thereto, a user may receive move orders and proceed to the housing office in person to complete a vacate notice. The housing office may have a computer available for the user to fill out the vacate notice on the system. In this way, the user can electronically complete a form and either send it electronically to the housing officer or the housing officer can immediately print out the completed form from the system.

The invention may have a referral component to notify the user's next housing office that the user is vacating his or her residence. As shown in FIG. 13B, the vacate notice may have an option to alert a housing office at the user's next duty station. In this way, RCI partners may work together to assist housing applicants in finding new housing from another RCI partner, although not limited to this embodiment. Some or all of the information collected to complete the vacate notice may be sent to the referral partner housing office so that the housing office at the user's next duty station can help set up housing for the user.

While the present invention has been described above in terms of specific embodiments, it is to be understood that the invention is not limited to these disclosed embodiments. Many modifications and other embodiments of the invention will come to mind to those skilled in the art to which this invention pertains, and which are intended to be and are covered by both this disclosure and the appended claims. It is intended that the scope of the invention should be determined by proper interpretation and construction of the appended claims and their legal equivalents, as understood by those of skill in the art relying upon the disclosure in this specification and the attached drawings.

What is claimed is:

1. A method of automating housing form completion, comprising the steps of:
assigning form fields to one or more housing forms stored on computer-readable medium,
mapping each form field to a database field,
enabling selection, on a computer, of the one or more housing forms for completion;
providing data entry fields, on a computer, for user data required to complete the one or more housing forms;
saving the user data in a database on a computer;
completing the selected one or more housing forms with the user data on a computer by filling out the form fields with the user data; and
creating one or more electronic files, on computer-readable medium, of the completed one or more forms.

2. The method of claim 1 wherein the forms relate to military housing.

3. The method of claim 2 wherein the one or more forms for selection are based upon a particular military base.

4. The method of claim 1 wherein the forms relate to educational housing and the forms for selection are based upon a particular educational institution.

5. The method of claim 1 further comprising electronic notification of the files(s) creation to a predetermined list of recipients stored on computer-readable medium.

6. The method of claim 1 further comprising electronic notification to a predetermined list of one or more referral partners when a user indicates an intent to move to the second location, wherein the predetermined list is stored on computer-readable medium and the one or more referral partners have housing at the second location.

7. The method of claim 1 wherein the data entry fields permit a user to choose to be contacted by predetermined goods and service providers.

8. The method of claim 1 wherein the user selects more than one form to complete.

9. The method of claim 1 wherein the user data in the database can be accessed by a user with a username and password.

10. A computer in a communications network for carrying out the method of claim 1.

11. The method of claim 1 further comprising computer-readable medium containing instructions for carrying out the method.

12. The method of claim 1 further comprising a communications network having a computer for carrying out the method.

13. A system for automating housing form completion, comprising:
a computer;
a logic engine communicating with the computer having information about one or more housing forms, the information comprising form field information;
a graphical user interface communicating with the computer that provides input fields for user data needed to complete the one or more housing forms;
a database communicating with the computer to store the user data;
wherein the logic engine loads the user data into the one or more housing forms and creates one or more electronic files on computer-readable media of the completed one or more forms.

14. The system of claim 13 wherein the one or more housing forms relate to military housing.

15. The system of claim 14 wherein the one or more housing forms are based upon a particular military base.

16. The system of claim 13 wherein the one or more housing forms relate to educational housing and the one or more housing forms are based upon a particular educational institution.

17. The system of claim 13 further comprising electronic notification of the creation of the one or more electronic files to a predetermined list of recipients stored on computer-readable medium

18. The system of claim 13 further comprising electronic notification to a predetermined list of one or more referral partners when a user indicates an intent to move to the second location, wherein the predetermined list is stored on computer-readable medium and the one or more referral partners have housing at the second location.

19. The system of claim 13 wherein the graphical user interface includes the ability to choose to be contacted by predetermined goods and service providers.

20. The system of claim 13 wherein the user data in the database can be accessed by a user with a username and password.
